(19) United States
(12) Patent Application Publication
(10) Pub. No.: US 2025/0335261 A1
(43) Pub. Date: Oct. 30, 2025

(54) DYNAMIC THROTTLING OF WRITE INPUT/OUTPUT (IO) OPERATIONS

(71) Applicant: Dell Products L.P., Round Rock, TX (US)

(72) Inventors: Michael Scharland, Franklin, MA (US); Jaeyoo Jung, Shrewsbury, MA (US); Ramesh Doddaiah, Westborough, MA (US)

(73) Assignee: Dell Products L.P., Round Rock, TX (US)

(21) Appl. No.: 18/650,324

(22) Filed: Apr. 30, 2024

(51) Int. Cl. G06F 9/50

(52) U.S. Cl. CPC G06F 9/505; G06F 9/5016; G06F 9/5038

(57) ABSTRACT

One or more aspects of the present disclosure relate to dynamic throttling of write input/output (IO) operations. In embodiments, an input/output (IO) workload, including mixed-size write IO requests, is received by a storage array. A subset of the mixed-size write IO requests can correspond to random write misses (RWMs). In addition, a shark fin shapelet of response times for executing the mixed-size write IO requests corresponding to the RWMs is detected. Further, processing of the subset of mixed-size write IO requests corresponding to the RWMs is dynamically throttled in response to detecting the shark fin shapelet of response times.

### BACKGROUND

A storage array performs block-based, file-based, or object-based storage services. Rather than store data on a server, storage arrays can include multiple storage devices (e.g., drives) to store vast amounts of data. For example, a financial institution can use storage arrays to collect and store financial transactions from local banks and automated teller machines (ATMs) related to bank account deposits/withdrawals. In addition, storage arrays can include a central management system (CMS) that manages the data and delivers one or more distributed storage services for an organization. The central management system can include one or more processors that perform data storage services.

### SUMMARY

One or more aspects of the present disclosure relate to dynamic throttling of write input/output (IO) operations. In embodiments, an input/output (IO) workload, including mixed-size write IO requests, is received by a storage array. A subset of the mixed-size write IO requests can correspond to random write misses (RWMs). In addition, a shark fin shapelet of response times for executing the mixed-size write IO requests corresponding to the RWMs is detected. Further, processing of the subset of mixed-size write IO requests corresponding to the RWMs is dynamically throttled in response to detecting the shark fin shapelet of response times.

In embodiments, a graphical representation of the response times for executing the mixed-size write IO requests corresponding to the RWMs can be generated. Additionally, a burst in response times of a set of the mixed-size write IO requests corresponding to the RWMs can be identified. Further, whether the burst forms the shark fin shapelet can be determined. For example, the set of mixed-size write IO requests having response times greater than a threshold can form the shark fin shapelet.

In embodiments, an arrival rate and an expected execution time of the subset of the mixed-size write IO requests corresponding to the RWMs during each time window (W) can be monitored. In addition, a number of cache slots allocated for each distinctly sized mirrored memory cache slot pool of a plurality of variably sized cache slot pools during each time window can be determined. Further, a portion of the subset of the mixed-size IO write requests corresponding to the RWMs during each time window can be buffered in a queue. For example, the buffered portion can correspond to an outstanding write IO count (WC) that can include an outstanding number of large block IO write requests (LBWs) and an outstanding number of small block IO write requests (SBWs).

In embodiments, the outstanding number of SBWs from the queue can be processed with a priority higher than the outstanding LBWs in the queue. In addition, an N number of the outstanding LBWs can be processed from the queue during each time window.

In embodiments, a value of the N number of LBWs can be dynamically changed during a subject time window within a threshold based on current IO latency trends. Further, the threshold can be determined based on the number of cache slots for each distinctly sized mirrored memory cache slot pool of the plurality of variably sized cache slot pools during the subject time window during which one or more mirrored pool cache slot allocations change.

In embodiments, a service level corresponding to each outstanding LBW in the queue can be determined. Additionally, processing the outstanding LBWs in the queue can be throttled based on their respective service levels.

In embodiments, a timer can be established to delay processing the throttled outstanding LBWs in the queue. Further, the throttled outstanding LBWs in the queue can be processed after an expiration of the timer.

In embodiments, a skew in the response times for executing the mixed-size write IO requests corresponding to the RWMs can be measured using a latency distribution model during each time window. In addition, one or more of a mean response time, median response time, response time standard deviation, and moving average of IO arrival rates can be determined during each time window.

In embodiments, a greater number of LBWs from the queue can be processed if the IO arrival rate of the subject time window is less than or equal to a previous time window.

In embodiments, a throttling threshold corresponding to processing the outstanding LBWs in the queue can be monotonically increased or decreased within a hard limit.

Other technical features may be readily apparent to one skilled in the art from the following figures, descriptions, and claims.

### BRIEF DESCRIPTION OF THE DRAWINGS

The preceding and other objects, features, and advantages will be apparent from the following more particular description of the embodiments, as illustrated in the accompanying drawings. Like reference, characters refer to the same parts throughout the different views. The drawings are not necessarily to scale, emphasis instead being placed upon illustrating the embodiments' principles.

FIG. 1 illustrates a distributed network environment in accordance with embodiments of the present disclosure.

FIG. 2 is a cross-sectional view of a storage device in accordance with embodiments of the present disclosure.

FIG. 3 is a block diagram of a controller in accordance with embodiments of the present disclosure.

FIG. 4 is a graph of input/output (IO) response times in accordance with embodiments of the present disclosure.

FIG. 5 is a flow diagram of a method for dynamically throttling write input/output (IO) operations per embodiments of the present disclosure.

### DETAILED DESCRIPTION

A business like a financial or technology corporation can produce large amounts of data and require sharing access to that data among several employees. Such a business often uses storage arrays to store and manage the data. Because a storage array can include multiple storage devices (e.g., hard-disk drives (HDDs) or solid-state drives (SSDs)), the business can scale (e.g., increase or decrease) and manage an array's storage capacity more efficiently than a server. In addition, the business can use a storage array to read/write data required by one or more business applications.

In data storage, particularly within enterprise environments, the efficient management of input/output (IO) operations is critical for maintaining system performance and reliability. Traditional storage arrays often struggle with handling mixed-size write IO requests effectively, especially under conditions of high utilization. These challenges stem from the inherent variability in the size and frequency of the data requests, which can lead to unpredictable latency and reduced throughput.

Current naive storage systems employ static methods for managing these IO requests, utilizing fixed thresholds and queues that do not adapt to changing conditions. This approach often results in suboptimal performance, mainly when dealing with random write misses (RWMs) that vary significantly in size. Large block RWMs can monopolize system resources due to their size, causing smaller, yet often more critical, small block RWMs to experience delays. This imbalance affects the latency of individual requests and can lead to broader system inefficiencies, such as increased CPU cycle consumption and IO operations per second (IOPS) oscillation.

Moreover, these systems cannot dynamically adjust their operations based on real-time analysis of IO request patterns and system performance metrics. As a result, these systems cannot effectively prioritize tasks or optimize the allocation of memory resources, leading to persistent issues with latency spikes and resource bottlenecks.

Embodiments of the present disclosure relate to adaptive and efficient techniques for managing mixed-size write IO requests in storage arrays. The techniques leverage real-time data to dynamically adjust processing strategies, thereby maintaining consistent latency, optimizing resource usage, and enhancing overall system performance. For example, the embodiments introduce a dynamic throttling technique that adjusts the processing of mixed-size write IO requests based on real-time system performance monitoring, prioritizes small block writes, and allocates memory resources more effectively to maintain low and consistent latency as described in greater detail herein.

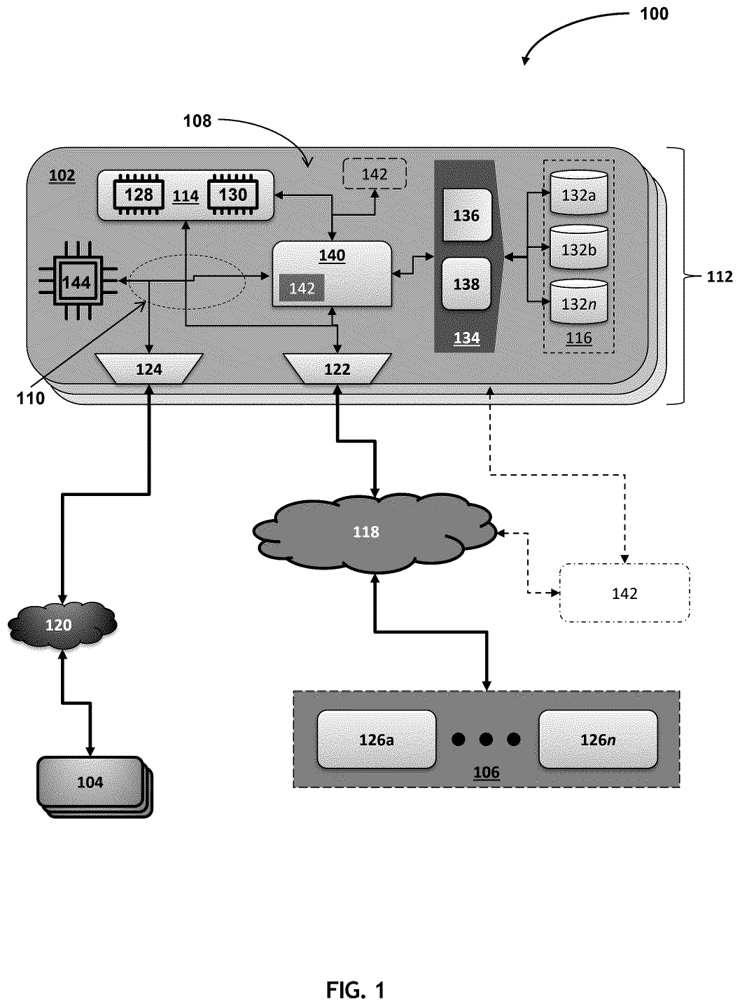

Regarding FIG. 1, a distributed network environment 100 can include a storage array 102, a remote system 104, and hosts 106. In embodiments, the storage array 102 can include components 108 that perform one or more distributed file storage services. In addition, the storage array 102 can include one or more internal communication channels 110 like Fibre channels, busses, and communication modules that communicatively couple the components 108. Further, the distributed network environment 100 can define an array cluster 112, including the storage array 102 and one or more other storage arrays.

In embodiments, the storage array 102, components 108, and remote system 104 can include a variety of proprietary or commercially available single or multi-processor systems (e.g., parallel processor systems). Single or multi-processor systems can include central processing units (CPUs), graphical processing units (GPUs), and the like. Additionally, the storage array 102, remote system 104, and hosts 106 can virtualize one or more of their respective physical computing resources (e.g., processors (not shown), memory 114, and persistent storage 116).

In embodiments, the storage array 102 and, e.g., one or more hosts 106 (e.g., networked devices) can establish a network 118. Similarly, the storage array 102 and a remote system 104 can establish a remote network 120. Further, the network 118 or the remote network 120 can have a network architecture that enables networked devices to send/receive electronic communications using a communications protocol. For example, the network architecture can define a storage area network (SAN), local area network (LAN), wide area network (WAN) (e.g., the Internet), an Explicit Congestion Notification (ECN), Enabled Ethernet network, and the like. Additionally, the communications protocol can include a Remote Direct Memory Access (RDMA), TCP, IP, TCP/IP protocol, SCSI, Fibre Channel, Remote Direct Memory Access (RDMA) over Converged Ethernet (ROCE) protocol, Internet Small Computer Systems Interface (ISCSI) protocol, NVMe-over-fabrics protocol (e.g., NVMe-over-ROCEv2 and NVMe-over-TCP), and the like.

Further, the storage array 102 can connect to the network 118 or remote network 120 using one or more network interfaces. The network interface can include a wired/wireless connection interface, bus, data link, and the like. For example, a host adapter (HA 122), e.g., a Fibre Channel Adapter (FA) and the like, can connect the storage array 102 to the network 118 (e.g., SAN). Further, the HA 122 can receive and direct IOs to one or more of the storage array's components 108, as described in greater detail herein.

Likewise, a remote adapter (RA 124) can connect the storage array 102 to the remote network 120. Further, the network 118 and remote network 120 can include communication mediums and nodes that link the networked devices. For example, communication mediums can include cables, telephone lines, radio waves, satellites, infrared light beams, etc. The communication nodes can also include switching equipment, phone lines, repeaters, multiplexers, and satellites. Further, the network 118 or remote network 120 can include a network bridge that enables cross-network communications between, e.g., the network 118 and remote network 120.

In embodiments, hosts 106 connected to the network 118 can include client machines 126a-n, running one or more applications. The applications can require one or more of the storage array's services. Accordingly, each application can send one or more input/output (IO) messages (e.g., a read/write request or other storage service-related request) to the storage array 102 over the network 118. Further, the IO messages can include metadata defining performance requirements according to a service level agreement (SLA) between hosts 106 and the storage array provider.

In embodiments, the storage array 102 can include a memory 114, such as volatile or nonvolatile memory. Further, volatile and nonvolatile memory can include random access memory (RAM), dynamic RAM (DRAM), static RAM (SRAM), and the like. Moreover, each memory type can have distinct performance characteristics (e.g., speed corresponding to reading/writing data). For instance, the types of memory can include register, shared, constant, user-defined, and the like. Furthermore, in embodiments, the memory 114 can include global memory (GM 128) that can cache IO messages and their respective data payloads. Additionally, the memory 114 can include local memory (LM 130) that stores instructions that the storage array's processors 144 can execute to perform one or more storage-related services. For example, the storage array 102 can have a multi-processor architecture that includes one or more CPUs (central processing units) and GPUs (graphical processing units).

In addition, the storage array 102 can deliver its distributed storage services using persistent storage 116. For example, the persistent storage 116 can include multiple thin-data devices (TDATs) such as persistent storage drives 132a-n. Further, each TDAT can have distinct performance capabilities (e.g., read/write speeds) like hard disk drives (HDDs) and solid-state drives (SSDs).

Further, the HA 122 can direct one or more IOs to an array component 108 based on their respective request types and metadata. In embodiments, the storage array 102 can include a device interface (DI 134) that manages access to the array's persistent storage 116. For example, the DI 134 can include a disk adapter (DA 136) (e.g., storage device controller), flash drive interface 138, and the like that control access to the array's persistent storage 116 (e.g., storage devices 132a-n).

Likewise, the storage array 102 can include an Enginuity Data Services processor (EDS 140) that can manage access to the array's memory 114. Further, the EDS 140 can perform one or more memory and storage self-optimizing operations (e.g., one or more machine learning techniques) that enable fast data access. Specifically, the operations can implement techniques that deliver performance, resource availability, data integrity services, and the like based on the SLA and the performance characteristics (e.g., read/write times) of the array's memory 114 and persistent storage 116. For example, the EDS 140 can deliver hosts 106 (e.g., client machines 126a-n) remote/distributed storage services by virtualizing the storage array's memory/storage resources (memory 114 and persistent storage 116, respectively).

In embodiments, the storage array 102 can also include a controller 142 (e.g., management system controller) that can reside externally from or within the storage array 102 and one or more of its components 108. When external from the storage array 102, the controller 142 can communicate with the storage array 102 using any known communication connections. For example, the communications connections can include a serial port, parallel port, network interface card (e.g., Ethernet), etc. Further, the controller 142 can include logic/circuitry that performs one or more storage-related services, such as managing the storage array's computing, processing, storage, and memory resources, as described in greater detail herein.

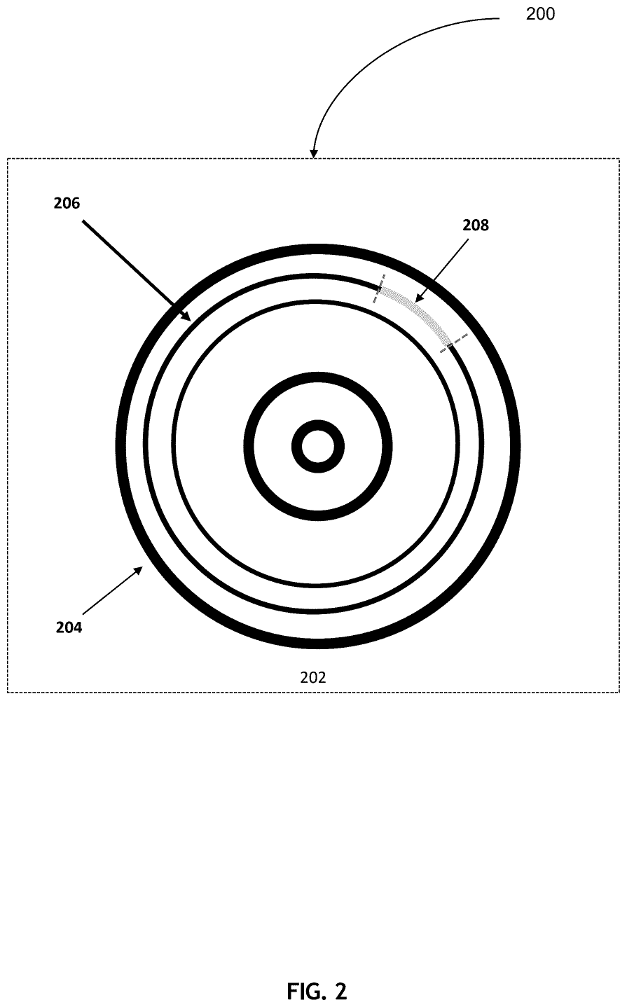

Regarding FIG. 2, the storage array's EDS 140 can virtualize the array's persistent storage 116. Specifically, the EDS 140 can virtualize a storage device 200, which is substantially like one or more of the storage devices 132a-n. For example, the EDS 140 can provide a host, e.g., client machine 126a, with a virtual storage device (e.g., thin-device (TDEV)) that logically represents zero or more portions of each storage device 132a-n. For example, the EDS 140 can establish a logical track using zero or more physical address spaces from each storage device 132a-n. Specifically, the EDS 140 can establish a continuous set of logical block addresses (LBA) using physical address spaces from the storage devices 132a-n. Thus, each (LBA) represents a corresponding physical address space from one of the storage devices 132a-n. For example, a track can include 256 LBAs, amounting to 128 kb of physical storage space. Further, the EDS 140 can establish the TDEV using several tracks based on the desired storage capacity of the TDEV. The EDS 140 can also establish extents that logically define a group of tracks.

In embodiments, the EDS 140 can provide each TDEV with a unique identifier (ID) like a target ID (TID). Additionally, EDS 140 can establish a logical unit number (LUN) that maps each track of a TDEV to its corresponding physical track location using pointers. Further, the EDS 140 can also generate a searchable data structure, mapping logical storage representations to their corresponding physical address spaces. Thus, EDS 100 can enable the HA 122 to present the hosts 106 with the logical storage representations based on host or application performance requirements.

For example, the persistent storage 116 can include an HDD 202 with stacks of cylinders 204. Like a vinyl record's grooves, each cylinder 204 can include one or more tracks 206. Each track 206 can include continuous sets of physical address spaces representing each of its sectors 208 (e.g., slices or portions thereof). The EDS 140 can provide each slice/portion with a corresponding logical block address (LBA). The EDS 140 can also group sets of continuous LBAs to establish one or more tracks. Further, the EDS 140 can group a set of tracks to establish each extent of a virtual storage device (e.g., TDEV). Thus, each TDEV can include tracks and LBAs corresponding to the persistent storage 116 or portions thereof (e.g., tracks and address spaces).

As stated herein, the persistent storage 116 can have distinct performance capabilities. For example, an HDD architecture is known by skilled artisans to be slower than an SSD's architecture. Likewise, the array's memory 114 can include different memory types, each with distinct performance characteristics described herein. In embodiments, the EDS 140 can establish a storage or memory hierarchy based on the SLA and the performance characteristics of the array's memory/storage resources. For example, the SLA can include one or more Service Level Objectives (SLOs) specifying performance metric ranges (e.g., response times and uptimes) corresponding to the hosts' performance requirements.

Further, the SLO can specify service level (SL) tiers corresponding to each performance metric range and categories of data importance (e.g., critical, high, medium, low). For example, the SLA can map critical data types to an SL tier requiring the fastest response time. Thus, the storage array 102 can allocate the array's memory/storage resources based on an IO workload's anticipated volume of IO messages associated with each SL tier and the memory hierarchy.

For example, the EDS 140 can establish the hierarchy to include one or more tiers (e.g., subsets of the array's storage and memory) with similar performance capabilities (e.g., response times and uptimes). Thus, the EDS 140 can establish fast memory and storage tiers to service host-identified critical and valuable data (e.g., Platinum, Diamond, Gold, Silver, and Bronze SLs). In contrast, slow memory and storage tiers can service host-identified, non-critical, less valuable data (e.g., Silver and Bronze SLs). The EDS 140 can also define “fast” and “slow” performance metrics based on relative performance measurements of the array's memory 114 and persistent storage 116. Thus, the fast tiers can include memory 114 and persistent storage 116, with relative performance capabilities exceeding a first threshold. In contrast, slower tiers can include memory 114 and persistent storage 116, with relative performance capabilities falling below a second threshold. Further, the first and second thresholds can correspond to the same threshold.

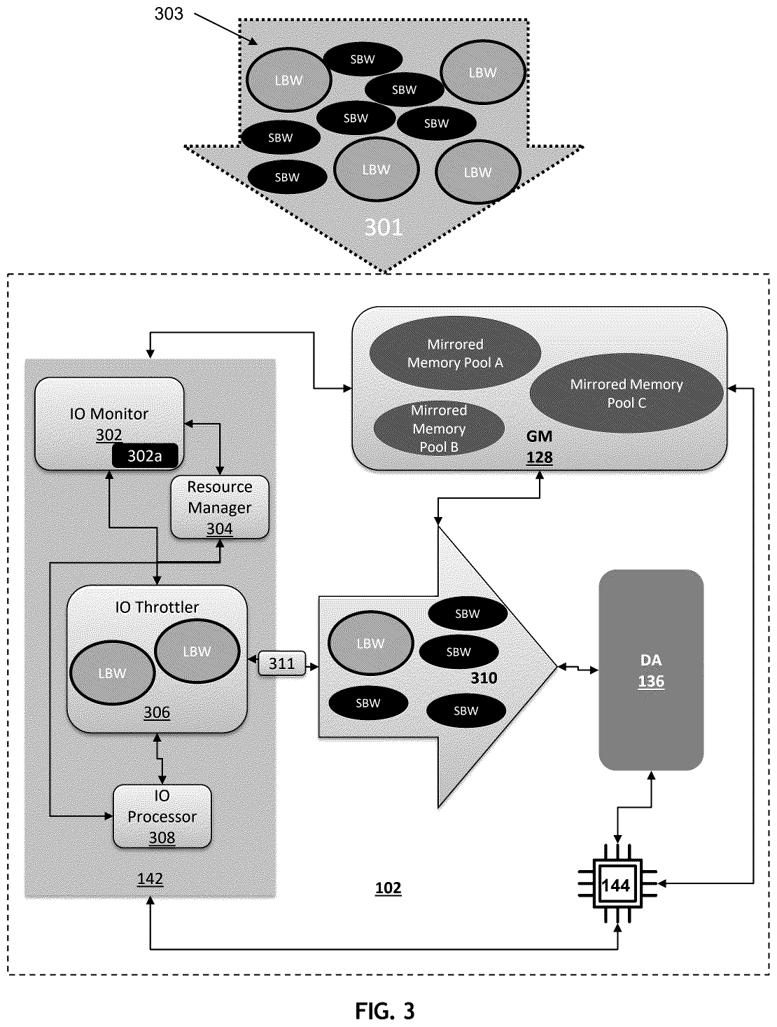

Regarding FIG. 3, the storage array 102 can receive an IO workload 301 with IO requests/operations 303 corresponding to large block writes (LBWs) and small block writes (SBWs). The LBWs can correspond to IO write requests having a size greater than a first threshold, and the SBWs can correspond to IO write requests smaller than a second threshold. In embodiments, the first threshold and the second threshold can be equivalent.

In embodiments, the IO workload 31 can include IO requests 303 corresponding to mixed-sized random write misses (RWMs). For example, an RWM occurs when an IO request targets a track without an allocated cache slot in one of the mirrored memory pools A-C in global memory (GM) 128. Specifically, the storage array 102 can include a controller 142 that checks if any cache slots in the mirrored memory pools A-C store data associated with an address corresponding to the IO request's target track. The IO request results in an RWM if the data is not found. Because the data is not in the cache, the controller 142 must retrieve it from slower, secondary storage, like a hard disk or SSD in persistent storage (e.g., the persistent storage 116 of FIG. 1).

Thus, each RWM leads to increased data processing latency and storage array response times. Further, processing RWMs can require more processing (CPU) resources (e.g., processors 142) and memory resources to manage fetching data from the secondary storage and organize the cache in the GM 128 than those required to process write hits. For example, write hits occur when IO requests 303 target data already present in a cache slot of the GM 128.

In embodiments, the storage array 102 can include a controller 142, including logic/circuitry for performing one or more storage-related services, such as managing the storage array's computing, processing, storage, and memory resources. The controller 142 can include an IO monitor 302 that continuously observes and records metrics related to the performance and behavior of the storage array 102. For example, the IO monitor 302 can track data corresponding to the IO requests 303 in an IO workload 301. The data can include the size (e.g., data block size), frequency, type (read or write), and processing time for each IO request 303. Additionally, the IO monitor 302 can monitor the storage array's resources, like CPU usage, memory utilization, and cache status.

Specifically, the IO monitor 302 can parse metadata from each IO request 303 to maintain a data log of IO characteristics of the IO workload 301. The data log can define whether an IO request is a read or write operation, the data block size involved, IO arrival rates, expected execution times, and whether the operation resulted in a hit or a miss in the cache. Additionally, the IO monitor 302 monitors the usage levels of critical storage array resources such as CPU, memory (e.g., RAM), and cache memory, facilitating the identification of potential bottlenecks or inefficiencies in resource usage. Moreover, by monitoring the usage levels of critical storage array resources, the IO monitor 302 can determine the time taken to process each IO operation, providing insights into the storage array's response times. Further, the IO monitor 302 can perform a throughput analysis by measuring the number of operations handled per unit of time, which helps assess the system's overall efficiency.

In embodiments, the IO monitor 302 can include a machine learning (ML) engine 302a configured to analyze the data and data log monitored and maintained by the IO monitor 302. The ML engine 302a can include logic/circuitry with a data clustering, neural network, or decision tree-type architecture to detect patterns and anomalies in data. For example, the ML engine 302a can process current/historical data and data logs to identify unusual patterns in data that deviate from normal operations. The unusual data patterns can include latency spikes, unusual resource usage levels, or unexpected error rates.

In embodiments, mixed-sized RWMs can cause latency spikes (or response time bursts). For example, the latency corresponding to processing random large block write misses corresponding to LBWs increases the latency of random small block write misses because LBWs and SBWs share write processing queues 310 of corresponding storage array processors (e.g., processors 144). For example, the ML engine 302a can generate right-/left-skewed Poisson distribution graphs that show average IO response times.

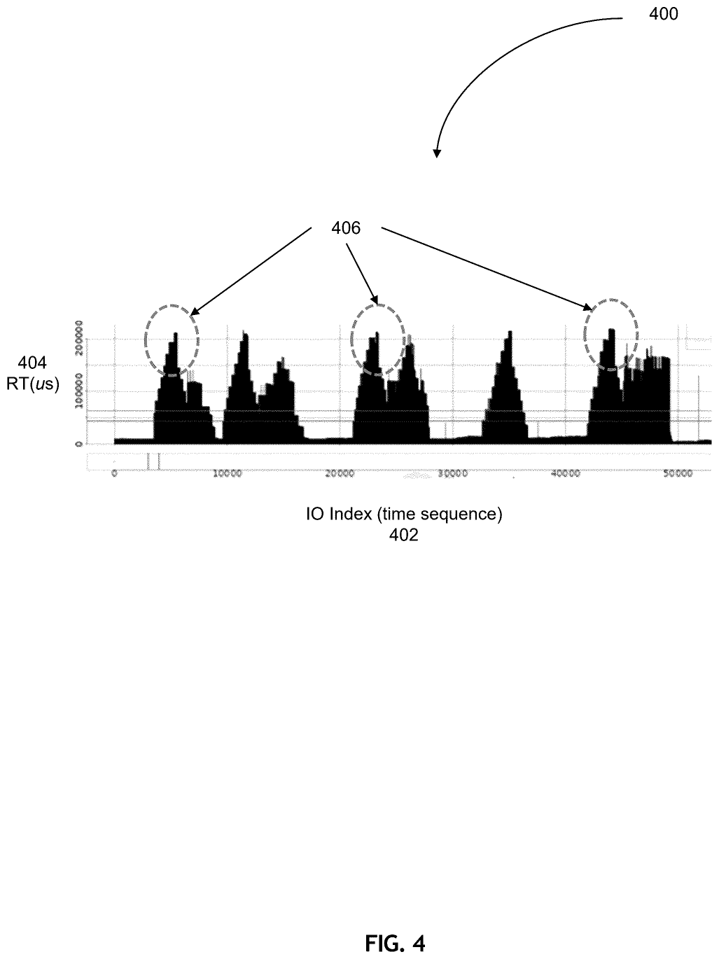

Regarding FIG. 4, the ML engine 302a can generate a graph 400 that plots an IO Index (time sequence) 402 vs response time (RT) in milliseconds (μs). Using the graph 400, the ML engine 302a can identify bursts in response times of the mixed-size write IO requests corresponding to RWMs. Further, the ML engine 302a can determine if the burts define a shark fin shapelet 406, indicating a need for IO throttling.

Referring back to FIG. 3, the controller 142 can include a resource manager (RM) 304 that dynamically manages cache slot allocations of mirrored memory pools A-C in global memory 128, each pool corresponding to distinct cache slot sizes (e.g., 8 kb, 32 kb, and 128 kb).

In embodiments, the RM 304 can receive (e.g., continuously) data from the IO monitor 302 about the types and sizes of IO write requests 303 in the IO workload 301 during one or more time windows. Additionally, the data can include information corresponding to historical/current amounts and frequencies of LBW and SBW requests received by the storage array 102. Further, the RM 304 can evaluate historical//current cache slot utilization of the mirrored memory pools A-C. For instance, the RM 304 can determine which write request block sizes are filling up the cache and how quickly these blocks are accessed and cleared. Based on the analysis and data from the IO monitor 302, the RM 304 can adjust the number of cache slots allocated to the mirrored memory pools A-C.

For example, if there is a high frequency of small block write requests, the RM 304 can increase the number of cache slots allocated to the mirrored memory pool with cache slot sizes corresponding to small block write requests. Conversely, if large block write requests are less frequent but take up more space, the RM might allocate fewer but larger cache slots to the mirrored memory pool corresponding to large block write requests. Further, the RM 304 can allocate cache slots to the mirrored memory pools A-C based on access frequencies of LBWs and SBWs. Additionally, the RM 304 can adjust cache slot allocations based on the performance of the storage array 102 (e.g., response times). Moreover, the RM 304 can monitor the impact of changes to cache slot allocations on system performance to adjust the allocations further, if necessary.

Advantageously, the RM 304 can dynamically adjust the number of cache slots for different-sized block writes and their corresponding mirrored memory pools A-C to maintain an optimal balance between cache space utilization and storage array performance. By dynamically adjusting cache slot allocations, the storage array 102 can handle variable IO workloads (e.g., workload 301) without unnecessary delays or resource wastage, leading to improved response times.

Further, the controller 142 can include an IO throttler 306 that manages and regulates the flow of data processing tasks within the storage array 102, mainly focusing on IO operations (e.g., IO requests 303). For example, the IO throttler 306 can dynamically adjust processing rates or resource allocations to improve performance and prevent system overloads.

In embodiments, the IO throttler 306 can temporarily store IO requests 303 corresponding large-/small-block write misses in a buffer 311. The number of LBWs and SBWs stored in the buffer 311 correspond to an outstanding write IO count. Further, if the IO monitor 302 detects a shark fin shapelet during a time window, the IO throttler 306 can release the outstanding number of SBWs from the buffer 311 with a higher priority than the outstanding LBWs in the buffer 311 during the time window corresponding to a shark fin shapelet. Additionally, the IO throttler 306 can release an N number of the outstanding LBWs from the buffer 311 during the time window based on IO latency trends. Furthermore, the IO throttler 306 can dynamically change the value of the N number of the outstanding LBWs within a threshold to be processed from the buffer 311 based on current IO latency trends. For example, the IO throttler 306 can dynamically determine the threshold based on the number of cache slots allocated to the mirrored memory pools A-C, respectively, during the time window.

Further, the IO throttler 306 can throttle the release of LBWs not released from the buffer 311 as part of the N number of outstanding LBWs released from the buffer 311 according to a timer wheel. For example, the timer wheel defines a delay for releasing each throttled LBW in the buffer 311 for release into the processing queue. Accordingly, the throttled LBWs are released after the delay expires. Specifically, the IO throttler 306 can assign each LBW associated with an expired timer with a priority equal to or greater than SBWs stored in the buffer 311 during the time window.

In embodiments, the controller 142 can include an IO processor 308 that releases a subset of the LBWs and SBWs in the buffer 311 into a processing queue 310. The LBWs and SBWs released into the processing queue correspond to an active IO count. For instance, the IO processor 308 can process released LBWs and SBWs according to their assigned priority levels. During a time window corresponding to a shark fin shapelet, the IO processor 308 can process SBW in the processing queue 310 with a higher priority than LBWs. Additionally, the IO processor 308 can process LBWs from the processing queue 310 according to their corresponding service levels (e.g., Platinum, Diamond, Gold, Silver, and Bronze).

The following text includes details of a method(s) or a flow diagram(s) per embodiments of this disclosure. For simplicity of explanation, each method is depicted and described as a set of alterable operations. Additionally, one or more operations can be performed in parallel, concurrently, or in a different sequence. Further, not all the illustrated operations are required to implement each method described by this disclosure.

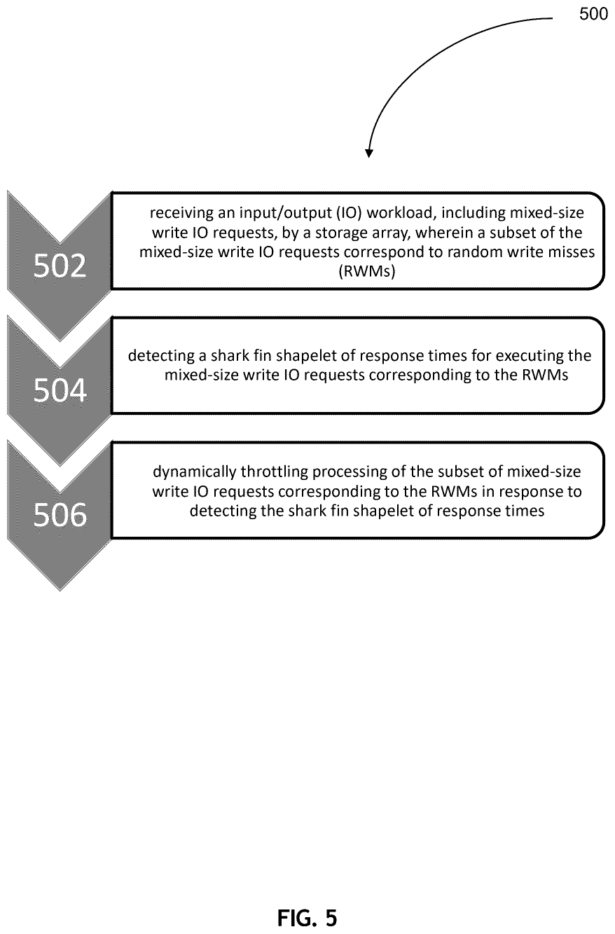

Regarding FIG. 5, a method 500 relates to dynamic throttling of write input/output (IO) operations. In embodiments, the controller 142 of FIG. 1 can perform all or a subset of operations corresponding to the method 500.

For example, the method 500, at 502, can include receiving an input/output (IO) workload, including mixed-size write IO requests, by a storage array (e.g., the storage array 102 of FIG. 1). Additionally, a subset of the mixed-size write IO requests can correspond to random write misses (RWMs). At 504, the method 500 can include detecting a shark fin shapelet of response times for executing the mixed-size write IO requests corresponding to the RWMs. Further, the method 500, at 506, can include dynamically throttling processing of the subset of mixed-size write IO requests corresponding to the RWMs in response to detecting the shark fin shapelet of response times.

Further, each operation can include any combination of techniques implemented by the embodiments described herein. Additionally, one or more of the storage array's components 108 can implement one or more of the operations of each method described above.

Using the teachings disclosed herein, a skilled artisan can implement the above-described systems and methods in digital electronic circuitry, computer hardware, firmware, or software. The implementation can be a computer program product. Additionally, the implementation can include a machine-readable storage device for execution by or to control the operation of a data processing apparatus. The implementation can, for example, be a programmable processor, a computer, or multiple computers.

A computer program can be in any programming language, including compiled or interpreted languages. The computer program can have any deployed form, including a stand-alone program, subroutine, element, or other units suitable for a computing environment. One or more computers can execute a deployed computer program.

One or more programmable processors can perform the method steps by executing a computer program to perform the concepts described herein by operating on input data and generating output. An apparatus can also perform the steps of the method. The apparatus can be a special-purpose logic circuitry. For example, the circuitry is an FPGA (field-programmable gate array) or an ASIC (application-specific integrated circuit). Subroutines and software agents can refer to portions of the computer program, the processor, the special circuitry, software, or hardware that implements that functionality.

Processors suitable for executing a computer program include, by way of example, both general and special purpose microprocessors and any one or more processors of any digital computer. A processor can receive instructions and data from a read-only memory, a random-access memory, or both. Thus, for example, a computer's essential elements are a processor for executing instructions and one or more memory devices for storing instructions and data. Additionally, a computer can receive data from or transfer data to one or more mass storage device(s) for storing data (e.g., magnetic, magneto-optical disks, solid-state drives (SSDs, or optical disks).

Data transmission and instructions can also occur over a communications network. Information carriers that embody computer program instructions and data include all nonvolatile memory forms, including semiconductor memory devices. The information carriers can, for example, be EPROM, EEPROM, flash memory devices, magnetic disks, internal hard disks, removable disks, magneto-optical disks, CD-ROM, or DVD-ROM disks. In addition, the processor and the memory can be supplemented by or incorporated into special-purpose logic circuitry.

A computer with a display device enabling user interaction can implement the above-described techniques, such as a display, keyboard, mouse, or any other input/output peripheral. The display device can, for example, be a cathode ray tube (CRT) or a liquid crystal display (LCD) monitor. The user can provide input to the computer (e.g., interact with a user interface element). In addition, other kinds of devices can enable user interaction. Other devices can, for example, be feedback provided to the user in any form of sensory feedback (e.g., visual feedback, auditory feedback, or tactile feedback). For example, input from the user can be in any form, including acoustic, speech, or tactile input.

A distributed computing system with a back-end component can also implement the above-described techniques. The back-end component can, for example, be a data server, a middleware component, or an application server. Further, a distributing computing system with a front-end component can implement the above-described techniques. The front-end component can, for example, be a client computer with a graphical user interface, a web browser through which a user can interact with an example implementation or other graphical user interfaces for a transmitting device. Finally, the system's components can interconnect using any form or medium of digital data communication (e.g., a communication network). Examples of communication network(s) include a local area network (LAN), a wide area network (WAN), the Internet, a wired network(s), or a wireless network(s).

The system can include a client(s) and server(s). The client and server (e.g., a remote server) can interact through a communication network. For example, a client-and-server relationship can arise when computer programs run on the respective computers and have a client-server relationship. Further, the system can include a storage array(s) that delivers distributed storage services to the client(s) or server(s).

Packet-based network(s) can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network(s), 802.16 network(s), general packet radio service (GPRS) network, HiperLAN), or other packet-based networks. Circuit-based network(s) can include, for example, a public switched telephone network (PSTN), a private branch exchange (PBX), a wireless network, or other circuit-based networks. Finally, wireless network(s) can include RAN, Bluetooth, code-division multiple access (CDMA) networks, time division multiple access (TDMA) networks, and global systems for mobile communications (GSM) networks.

The transmitting device can include, for example, a computer, a computer with a browser device, a telephone, an IP phone, a mobile device (e.g., cellular phone, personal digital assistant (PDA) device, laptop computer, electronic mail device), or other communication devices. The browser device includes, for example, a computer (e.g., desktop computer, laptop computer) with a World Wide Web browser (e.g., Microsoft® Internet Explorer® and Mozilla®). The mobile computing device includes, for example, a Blackberry®.

Comprise, include, or plural forms of each are open-ended, include the listed parts, and contain additional unlisted elements. Unless explicitly disclaimed, the term ‘or’ is open-ended and includes one or more of the listed parts, items, elements, and combinations thereof.

What is claimed is:

1. A method comprising:
receiving an input/output (IO) workload, including mixed-size write IO requests, by a storage array, wherein a subset of the mixed-size write IO requests correspond to random write misses (RWMs);
detecting a shark fin shapelet of response times for executing the mixed-size write IO requests corresponding to the RWMs; and
dynamically throttling processing of the subset of mixed-size write IO requests corresponding to the RWMs in response to detecting the shark fin shapelet of response times.

2. The method of claim 1, further comprising:
generating a graphical representation of the response times for executing the mixed-size write IO requests corresponding to the RWMs;
identifying a burst in response times of a set of the mixed-size write IO requests corresponding to the RWMs; and
determining whether the burst forms the shark fin shapelet, wherein the set of mixed-size write IO requests having response times greater than a threshold forms the shark fin shapelet.

3. The method of claim 1, further comprising:
monitoring an arrival rate and an expected execution time of the subset of the mixed-size write IO requests corresponding to the RWMs during each time window (W);
determining a number of cache slots allocated for each distinctly sized mirrored memory cache slot pool of a plurality of variably sized cache slot pools during each time window; and
buffering a portion of the subset of the mixed-size write IO requests corresponding to the RWMs during each time window in a queue, the buffered portion corresponding to an outstanding write IO count (WC) that includes an outstanding number of large block IO write requests (LBWs) and an outstanding number of small block IO write requests (SBWs).

4. The method of claim 3, further comprising:
processing the outstanding number of SBWs from the queue with a priority higher than the outstanding LBWs in the queue; and
processing an N number of the outstanding LBWs from the queue during each time window.

5. The method of claim 4, further comprising:
dynamically changing a value of the N number of LBWs during a subject time window within a threshold based on current IO latency trends; and
determining the threshold based on the number of cache slots for each distinctly sized mirrored memory cache slot pool of the plurality of variably sized cache slot pools during the subject time window during which one or more mirrored pool cache slot allocations change.

6. The method of claim 5, further comprising:
determining a service level corresponding to each outstanding LBW in the queue; and
throttling the processing of the outstanding LBWs in the queue based on their respective service levels.

7. The method of claim 6, further comprising:
establishing a timer to delay the processing of the throttled outstanding LBWs in the queue; and
processing the throttled outstanding LBWs in the queue after an expiration of the timer.

8. The method of claim 7, further comprising:
measuring a skew in the response times for executing the mixed-size write IO requests corresponding to the RWMs using a latency distribution model during each time window; and
determining one or more of a mean response time, median response time, response time standard deviation, and moving average of IO arrival rates during each time window.

9. The method of claim 8, further comprising:
processing a greater number of LBWs from the queue if the IO arrival rate of the subject time window is less than or equal to a previous time window.

10. The method of claim 9, further comprising:
monotonically increasing or decreasing a throttling threshold corresponding to processing the outstanding LBWs in the queue within a hard limit.

11. An apparatus with a memory and processor, the apparatus configured to:
receive an input/output (IO) workload, including mixed-size write IO requests, at a storage array, wherein a subset of the mixed-size write IO requests correspond to random write misses (RWMs);
detect a shark fin shapelet of response times for executing the mixed-size write IO requests corresponding to the RWMs; and
dynamically throttle processing of the subset of mixed-size write IO requests corresponding to the RWMs in response to detecting the shark fin shapelet of response times.

12. The apparatus of claim 11, further configured to:
generate a graphical representation of the response times for executing of the mixed-size write IO requests corresponding to the RWMs;
identify a burst in response times of a set of the mixed-size write IO requests corresponding to the RWMs; and
determine whether the burst forms the shark fin shapelet, wherein the set of mixed-size write IO requests having response times greater than a threshold forms the shark fin shapelet.

13. The apparatus of claim 11, further configured to:
monitor an arrival rate and an expected execution time of the subset of the mixed-size write IO requests corresponding to the RWMs during each time window (W);
determine a number of cache slots allocated for each distinctly sized mirrored memory cache slot pool of a plurality of variably sized cache slot pools during each time window; and
buffer a portion of the subset of the mixed-size write IO requests corresponding to the RWMs during each time window in a queue, the buffered portion corresponding to an outstanding write IO count (WC) that includes an outstanding number of large block IO write requests (LBWs) and an outstanding number of small block IO write requests (SBWs).

14. The apparatus of claim 13, further configured to:
process the outstanding number of SBWs from the queue with a priority higher than the outstanding LBWs in the queue; and
process an N number of the outstanding LBWs from the queue during each time window.

15. The apparatus of claim 14, further configured to:
dynamically change a value of the N number of LBWs during a subject time window within a threshold based on current IO latency trends; and
determine the threshold based on the number of cache slots for each distinctly sized mirrored memory cache slot pool of the plurality of variably sized cache slot pools during the subject time window during which one or more mirrored pool cache slot allocations change.

16. The apparatus of claim 15, further configured to:
determine a service level corresponding to each outstanding LBW in the queue; and
throttle the processing of the outstanding LBWs in the queue based on their respective service levels.

17. The apparatus of claim 16, further configured to:
establish a timer to delay the processing of the throttled outstanding LBWs in the queue; and
process the throttled outstanding LBWs in the queue after an expiration of the timer.

18. The apparatus of claim 17, further configured to:
measure a skew in the response times for executing the mixed-size write IO requests corresponding to the RWMs using a latency distribution model during each time window; and
determine one or more of a mean response time, median response time, response time standard deviation, and moving average of IO arrival rates during each time window.

19. The apparatus of claim 18, further configured to:
process a greater number of LBWs from the queue if the IO arrival rate of the subject time window is less than or equal to a previous time window.

20. The apparatus of claim 19, further configured to:
monotonically increase or decrease a throttling threshold corresponding to processing the outstanding LBWs in the queue within a hard limit.
